(19) United States
(12) Patent Application Publication
(10) Pub. No.: US 2024/0327682 A1
(43) Pub. Date: Oct. 3, 2024

(54) SECONDARY BATTERY AND ELECTRONIC APPARATUS

(71) Applicant: Ningde Amperex Technology Limited, Ningde (CN)

(72) Inventor: Kewen HU, Ningde (CN)

(73) Assignee: Ningde Amperex Technology Limited, Ningde (CN)

(21) Appl. No.: 18/621,272

(22) Filed: Mar. 29, 2024

(30) Foreign Application Priority Data
Mar. 31, 2023 (CN) 202310341003.0

(51) Int. Cl. C09J 11/08; C09J 7/25; C09J 7/30; C09J 153/02; H01M 10/0525; H01M 10/058; H01M 10/42; H01M 50/105

(52) U.S. Cl. CPC C09J 11/08; C09J 7/255; C09J 7/30; C09J 153/02; H01M 10/0525; H01M 10/058; H01M 10/4235; H01M 50/105; C09J 2203/33; C09J 2453/00; C09J 2467/006

(57) ABSTRACT

A secondary battery includes an electrode assembly, an electrolyte, a housing, and an adhesive member. The adhesive member includes a first adhesive layer and a second adhesive layer that are stacked. The adhesive member is disposed between the electrode assembly and the housing, where the first adhesive layer is attached to inner surface of the housing, and the second adhesive layer is attached to outer surface of the electrode assembly. The first adhesive layer includes a styrene-isoprene-styrene block copolymer and wax. Based on mass of the first adhesive layer, a mass percentage of the styrene-isoprene-styrene block copolymer is 65% to 95%, and a mass percentage of the wax is 1% to 5%. The adhesive member of the secondary battery in this application reduces occurrence of adhesive fall-off caused by friction, thereby improving safety performance of the secondary battery.

### CROSS-REFERENCE TO RELATED APPLICATION

The present application claims priority to Chinese Patent Application No. CN 202310341003.0, filed in the China National Intellectual Property Administration on Mar. 31, 2023, the entire content of which is hereby incorporated by reference.

### TECHNICAL FIELD

This application relates to the field of electrochemistry, and specifically, to a secondary battery and an electronic apparatus.

### BACKGROUND

In secondary batteries, due to presence of a certain gap between the electrode assembly and the housing, the electrode assembly will have relative movement against the housing, and an adhesive member needs to be used to insulate and fasten the secondary battery.

Commonly used adhesive members, such as styrene-isoprene-styrene block copolymer (SIS) adhesive tape, tend to experience partial adhesive fall-off due to friction during the production process of the secondary battery. As a result, bulges are present on surface of the secondary battery after packaging, leading to poor appearance. Moreover, this problem becomes more obvious with the use of the battery, affecting the safety performance of the secondary battery.

### SUMMARY

This application is intended to provide a secondary battery and an electronic apparatus to enhance safety performance of the secondary battery. Specific technical solutions are as follows:

A first aspect of this application provides a secondary battery, including an electrode assembly, an electrolyte, a housing, and an adhesive member. The adhesive member includes a first adhesive layer and a second adhesive layer that are stacked. The adhesive member is disposed between the electrode assembly and the housing, where the first adhesive layer is attached to inner surface of the housing, and the second adhesive layer is attached to outer surface of the electrode assembly. The first adhesive layer includes a styrene-isoprene-styrene block copolymer and wax. Based on mass of the first adhesive layer, a mass percentage of the wax is 1% to 5%. Without being bound by any theory, the inventors of this application have discovered that addition of a proper amount of wax in the first adhesive layer can reduce surface stickiness of the first adhesive layer, thereby reducing the occurrence of adhesive fall-off caused by friction on the adhesive member during the preparation of the secondary battery, thus enhancing the safety performance of the secondary battery.

In some embodiments of this application, the wax includes at least one of microcrystalline wax, paraffin wax, carnauba wax, polyethylene wax, or polypropylene wax.

In some embodiments of this application, based on the mass of the first adhesive layer, a mass percentage of the wax is 2% to 4%.

In some embodiments of this application, the first adhesive layer further includes a functional resin, and based on the mass of the first adhesive layer, a mass percentage of the styrene-isoprene-styrene block copolymer is 65% to 95%, and a mass percentage of the functional resin is 10% to 30%; and the functional resin includes at least one of ethylene-vinyl acetate copolymer, polyurethane elastomer, polyurethane acrylate, polyisobutylene, or polypropylene.

In some embodiments of this application, the first adhesive layer further includes an additive and an antioxidant. Based on the mass of the first adhesive layer, a mass percentage of the additive is 1% to 5%, and a mass percentage of the antioxidant is 1% to 5%.

In some embodiments of this application, the adhesive member further includes a substrate layer located between the first adhesive layer and the second adhesive layer. The substrate layer includes at least one of polyethylene terephthalate, polyimide, or polypropylene.

In some embodiments of this application, the first adhesive layer further includes a polar resin, where the polar resin includes a styrene-ethylene-butylene-polyethylene block copolymer and a polyolefin elastomer. Based on the mass of the first adhesive layer, a mass percentage of the polar resin is 5% to 10%, a mass percentage of the Styrene Ethylene Butylene Styrene (SEBS) is 3.5% to 9.5%, and a mass percentage of the polyolefin elastomer is 0.5% to 1.5%.

In some embodiments of this application, the housing is a packaging bag.

In some embodiments of this application, thickness of the first adhesive layer is 2 μm to 20 μm.

In some embodiments of this application, peeling strength between the first adhesive layer and the housing is 10 N/m to 500 N/m.

A second aspect of this application provides an electronic apparatus, including the secondary battery according to any one of the foregoing embodiments. The secondary battery provided in this application exhibits excellent safety performance, thereby ensuring that the electronic apparatus provided in this application also has good safety performance.

This application has the following beneficial effects:

This application provides a secondary battery and an electronic apparatus. The secondary battery includes an electrode assembly, an electrolyte, a housing, and an adhesive member. The adhesive member includes a first adhesive layer and a second adhesive layer that are stacked. The adhesive member is disposed between the electrode assembly and the housing, where the first adhesive layer is attached to inner surface of the housing, and the second adhesive layer is attached to outer surface of the electrode assembly. The first adhesive layer includes a styrene-isoprene-styrene block copolymer and wax. Based on mass of the first adhesive layer, a mass percentage of the wax is 1% to 5%. The secondary battery provided in this application includes the adhesive member, the adhesive member includes the stacked first adhesive layer and second adhesive layer. The first adhesive layer includes wax, which can reduce the surface stickiness of the first adhesive layer, thus reducing the occurrence of adhesive fall-off caused by friction of the adhesive member during the preparation of the secondary battery, further improving the safety performance of the secondary battery, and meeting the mass production processability of the secondary battery.

Certainly, when any one of the products or methods of this application is implemented, all advantages described above are not necessarily demonstrated simultaneously.

### BRIEF DESCRIPTION OF DRAWINGS

To describe the technical solutions in embodiments of this application or in the prior art more clearly, the following briefly describes the accompanying drawings required for describing the embodiments or the prior art. Apparently, the accompanying drawings in the following descriptions show merely some embodiments of this application, and persons of ordinary skill in the art may still derive other embodiments from the accompanying drawings.

FIG. 1 is a schematic diagram of a structure of an adhesive member according to some embodiments of this application;

FIG. 2 is a schematic diagram of a structure of an adhesive member according to some other embodiments of this application; and

FIG. 3 is an assembly diagram of a secondary battery according to some embodiments of this application.

Reference signs: secondary battery 100; housing 10; electrode assembly 20; adhesive member 30; first adhesive layer 31; second adhesive layer 32; and substrate layer 33.

### DETAILED DESCRIPTION

The following clearly and completely describes technical solutions in the embodiments of this application with reference to the accompanying drawings in the embodiments of this application. Apparently, the described embodiments are only some but not all of the embodiments of this application. Based on the embodiments of this application, all other embodiments obtained by persons of ordinary skill in the art based on this application shall fall within the protection scope of this application.

It should be noted that, in the specific embodiments of this application, a lithium-ion battery is used as an example of a secondary battery to explain this application. However, the secondary battery in this application is not limited to the lithium-ion battery.

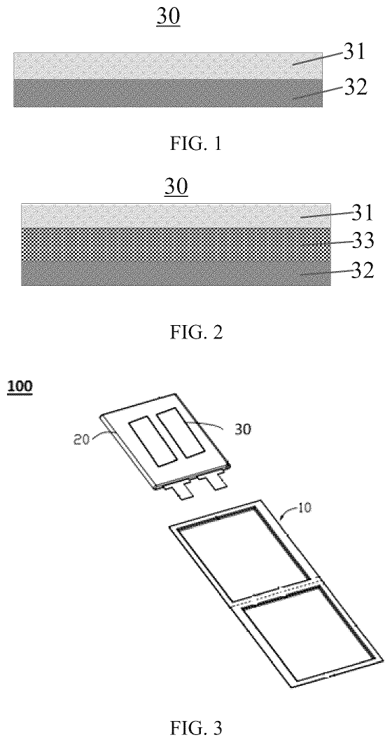

A first aspect of this application provides a secondary battery, including an electrode assembly, an electrolyte, a housing, and an adhesive member. As shown in FIG. 1, the adhesive member 30 includes a first adhesive layer 31 and a second adhesive layer 32 that are stacked. The adhesive member is disposed between the electrode assembly and the housing, where the first adhesive layer is attached to inner surface of the housing, and the second adhesive layer is attached to outer surface of the electrode assembly. The first adhesive layer includes a styrene-isoprene-styrene block copolymer (SIS) and wax. Based on mass of the first adhesive layer, a mass percentage of the wax is 1% to 5%. For example, the mass percentage of the wax can be 1%, 2%, 3%, 4%, 5%, or a range between any two of the above values. Without being bound by any theory, for a common SIS adhesive, during the use of the secondary battery, the first adhesive layer containing only SIS exhibits higher surface stickiness, weaker adhesion to the substrate layer, and dust accumulation on surface of the tape, which results in higher frictional resistance, thus leading to occurrence of adhesive fall-off caused by friction. When wax is added to the first adhesive layer, if the mass percentage of wax is excessively high, the peeling strength of the adhesive member will be reduced, and electrochemical stability of the adhesive member in the electrolyte will deteriorate. If the mass percentage of wax is excessively low, desired improvement to the safety performance of the secondary battery cannot be achieved. If the amount of wax added falls within the scope of the application, surface stickiness of the first adhesive layer can be reduced, thus reducing the occurrence of adhesive fall-off caused by friction of the adhesive member during the preparation of the secondary battery. In additional, the improved adhesive member exhibits lower swelling in the electrolyte, further ensuring the stability of the secondary battery during use and thus enhancing the safety performance of the secondary battery.

In some embodiments of this application, the wax includes at least one of microcrystalline wax, paraffin wax, carnauba wax, polyethylene wax, or polypropylene wax. Without being bound by any theory, addition of the foregoing types of wax to the adhesive member of the secondary battery can reduce the surface stickiness of the first adhesive layer and occurrence of adhesive fall-off caused by friction, thereby improving the safety performance of the secondary battery.

In some embodiments of this application, based on the mass of the first adhesive layer, a mass percentage of the wax is 2% to 4%. For example, the mass percentage of the wax can be 2%, 2.5%, 3%, 3.5%, 4%, or a range between any two of the above values. Controlling the mass percentage of the wax within the above range can reduce the surface stickiness of the first adhesive layer and the occurrence of adhesive fall-off caused by friction, thereby improving the safety performance of the secondary battery.

In some embodiments of this application, the first adhesive layer further includes a functional resin, and based on the mass of the first adhesive layer, a mass percentage of the styrene-isoprene-styrene block copolymer is 65% to 95%, and a mass percentage of the functional resin is 10% to 30%; and the functional resin includes at least one of ethylene-vinyl acetate copolymer, polyurethane elastomer, polyurethane acrylate, polyisobutylene, or polypropylene. For example, the mass percentage of the styrene-isoprene-styrene block copolymer can be 65%, 70%, 75%, 80%, 85%, 90%, 95%, or a range between any two of the above values, and the mass percentage of the functional resin can be 10%, 15%, 20%, 25%, or 30%, or a range between any two of the above values. Controlling the mass percentage of the styrene-isoprene-styrene block copolymer and the functional resin in the first adhesive layer within the foregoing range can reduce shape deformation of the adhesive member, resulting in reduced swelling and improved electrochemical stability of the adhesive member in the electrolyte, thereby improving safety performance of the secondary battery.

In some embodiments of this application, the first adhesive layer further includes an additive and an antioxidant. Based on the mass of the first adhesive layer, a mass percentage of the additive is 1% to 5%, and a mass percentage of the antioxidant is 1% to 5%. For example, the mass percentage of the additive can be 1%, 2%, 3%, 4%, 5%, or a range between any two of the above values, and the mass percentage of the antioxidant can be 1%, 2%, 3%, 4%, 5%, or a range between any two of the above values. Adding the additive within the above range to the first adhesive layer can enhance heat resistance of the adhesive member and reduce the shape deformation, thereby improving the safety performance of the secondary battery. Adding the antioxidant within the above range to the first adhesive layer can prevent oxidation failure of the adhesive member in a high-temperature and high-humidity electrolyte environment, thereby improving the safety performance of the secondary battery. The types of additive are not limited in this application as long as they achieve the objective of this application. For example, the additive includes at least one of titanium dioxide, talcum powder, blanc fixe, or calcium carbonate. The types of antioxidant are not limited in this application as long as they achieve the objective of this application. For example, the antioxidant includes at least one of diphenylamine, triphenyl phosphite, or octadecyl 3,5-di-tert-butyl-4-hydroxyhydrocinnamate.

In some embodiments of this application, as shown in FIG. 2, the adhesive member 30 further includes a substrate layer 33, and the substrate layer 33 is located between the first adhesive layer 31 and the second adhesive layer 32. The substrate layer includes at least one of polyethylene terephthalate, polyimide, or polypropylene. Good insulation property of the substrate layer can further improve the safety performance of the secondary battery and reduce the shape deformation of the adhesive member in a high-temperature environment.

In some embodiments of this application, the first adhesive layer further includes a polar resin, which includes styrene-ethylene-butylene-polyethylene block copolymer and polyolefin elastomer. Based on the mass of the first adhesive layer, a mass percentage of the polar resin is 5% to 10%, a mass percentage of the styrene-ethylene-butylene-polyethylene block copolymer is 3.5% to 9.5%, and a mass percentage of the polyolefin elastomer is 0.5% to 1.5%. For example, the mass percentage of the polar resin can be 5%, 6%, 7%, 8%, 9%, 10%, or a range between any two of the above values. The mass percentage of the styrene-ethylene-butylene-polyethylene block copolymer can be 3.5%, 4%, 4.5%, 5%, 5.5%, 6%, 6.5%, 7%, 7.5%, 8%, 8.5%, 9%, 9.5%, or a range between any two of the above values. The mass percentage of the polyolefin elastomer can be 0.5%, 1%, 1.5%, or a range between any two of the above values. Polyolefin elastomer (POE) is a thermoplastic elastomer formed by the in-situ polymerization of ethylene and α-olefin catalyzed using metallocene catalysts, where the metallocene catalyst refers to a catalyst system composed of a transition metal from group IVB (such as Ti, Zr, and Hf) as the main catalyst, and an alkylaluminum oxide (such as MAO) or an organic boron compound (such as B(C₆F₅)₃) as the cocatalyst. When the adhesive member includes a substrate layer, the addition of the polar resin to the first adhesive layer results in a more flexible molecular chain and lower cohesive force, allowing viscosity to be rapidly exerted at low temperatures to enhance the attachment of the first adhesive layer to the substrate layer. In addition, when an external force is applied, such structure can reduce probability of damaging the adhesive interface between the adhesive member and the electrode assembly, thereby improving the safety performance of the secondary battery.

In some embodiments of this application, the housing is a packaging bag, which can improve the safety performance of the secondary battery.

In some embodiments of this application, thickness of the first adhesive layer is 2 μm to 20 μm. For example, the thickness of the first adhesive layer can be 2 μm, 4 μm, 6 μm, 8 μm, 10 μm, 12 μm, 14 μm, 16 μm, 18 μm, 20 μm, or a range between any two of the above values. The thickness of the first adhesive layer is controlled within the above-mentioned range, which helps to reduce loss of energy density in the secondary battery and improve the safety performance of the secondary battery.

In some embodiments of this application, peeling strength between the first adhesive layer and the housing is 10 N/m to 500 N/m. For example, the peeling strength between the first adhesive layer and the housing can be 10 N/m, 50 N/m, 100 N/m, 150 N/m, 200 N/m, 250 N/m, 300 N/m, 350 N/m, 400 N/m, 450 N/m, 500 N/m, or a range between any two of the above values. Controlling the peeling strength between the first adhesive layer and the housing within the above-mentioned range helps to alleviate tearing of the electrode plate surface at the edge of the adhesive member, thereby enhancing the safety performance of the secondary battery. A material type of the second adhesive layer is not particularly limited in this application, provided that the purpose of this application can be achieved. For example, a material of the second adhesive layer includes at least one of polymethyl methacrylate (PMMA, commonly known as acrylic), polypropylene (PP), polyethylene (PE), or polyamide.

A preparation method of adhesive member is not particularly limited, provided that the purpose of this application can be achieved. For example, in this application, the adhesive member can be prepared by the following method: The styrene-isoprene-styrene block copolymer, wax, polar resin, functional resin, additive, and antioxidant are mixed. After thorough mixing, the mixture is applied onto a substrate layer to form a first adhesive layer, followed by drying at a temperature of 100° C. to 150° C. A material of a second adhesive layer is applied on the other side of the substrate layer to form the second adhesive layer, followed by drying at a temperature of 60° C. to 100° C., to obtain an adhesive member.

In this application, a weight-average molecular weight of the styrene-ethylene-butylene-styrene block copolymer is not particularly limited, and may be selected by persons skilled in the art based on an actual need, provided that the purpose of this application can be achieved. For example, the weight-average molecular weight of the styrene-ethylene-butylene-styrene block copolymer may be 20000 to 300000.

In some embodiments of this application, the secondary battery includes an electrode assembly, a housing, an adhesive member, and an electrolyte, where the electrode assembly and electrolyte are accommodated in the housing. A structure of the electrode assembly is not particularly limited in this application, provided that the purpose of this application can be achieved. For example, the electrode assembly may have a stacked structure, a wound structure, or a multi-tab structure. The electrode assembly includes a positive electrode plate, a negative electrode plate, and a separator, where the separator is disposed between the positive electrode plate and the negative electrode plate. The separator is configured to separate the positive electrode plate and the negative electrode plate, so as to prevent internal short-circuits in the secondary battery. The separator allows electrolyte ions to freely pass through to complete electrochemical charging and discharging processes.

The positive electrode plate in this application is not particularly limited, provided that the purpose of this application can be achieved. For example, the positive electrode plate includes a positive electrode current collector and a positive electrode active material layer. The positive electrode current collector is not particularly limited in this application, provided that the purpose of this application can be achieved. For example, the positive electrode current collector may include aluminum foil, aluminum alloy foil, a composite current collector, or the like. The positive electrode active material layer in this application includes a positive electrode active material. A type of the positive electrode active material is not particularly limited in this application, provided that the purpose of this application can be achieved. For example, the positive electrode active material layer may include at least one of nickel cobalt lithium manganese oxide (NCM811, NCM622, NCM523, NCM111), lithium nickel cobalt aluminum oxide, lithium iron phosphate, lithium-rich manganese-based materials, lithium cobalt oxide (LiCoO₂), lithium manganese oxide, lithium iron manganese phosphate, or lithium titanate. In this application, the positive electrode active material may further contain a non-metal element. For example, the non-metal element includes at least one of fluorine, phosphorus, boron, chlorine, silicon, or sulfur. These elements can further improve stability of the positive electrode active material. In this application, thicknesses of the positive electrode current collector and positive electrode active material layer are not particularly limited, provided that the purpose of this application can be achieved. For example, the thickness of the positive electrode current collector is 5 μm to 20 μm, and preferably 6 μm to 18 μm. A thickness of a one-sided positive electrode active material layer is 30 μm to 120 μm. In this application, the negative electrode active material layer may be disposed on one surface of the positive electrode current collector in a thickness direction, or may be disposed on two surfaces of the positive electrode current collector in a thickness direction. Optionally, the positive electrode active material layer may further include a conductive agent and a binder. A type of the binder in the positive electrode active material layer is not particularly limited in this application, provided that the purpose of this application can be achieved. For example, the binder may include but is not limited to at least one of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, or polyhexafluoropropylene. The conductive agent in the positive electrode active material layer is not particularly limited in this application, provided that the purpose of this application can be achieved. For example, the conductive agent may include but is not limited to at least one of conductive carbon black (Super P), carbon nanotubes (CNTs), carbon fibers, flake graphite, Ketjen black, graphene, metal material, or conductive polymer. The carbon nanotubes may include but are not limited to single-walled carbon nanotubes and/or multi-walled carbon nanotubes. The carbon fibers may include but are not limited to vapor grown carbon fibers (VGCF) and/or carbon nanofibers. The above metal material may include but is not limited to metal powder and/or metal fiber, and specifically, the metal may include but is not limited to at least one of copper, nickel, aluminum, or silver. The above conductive polymer may include but is not limited to at least one of polyphenylene derivative, polyaniline, polythiophene, polyacetylene, or polypyrrole. A mass ratio of the positive electrode active material, conductive agent, and binder in the positive electrode active material layer is not particularly limited in this application, and can be selected by persons skilled in the art based on an actual need, provided that the purpose of this application can be achieved.

The negative electrode plate in this application is not particularly limited, provided that the purpose of this application can be achieved. For example, the negative electrode plate includes a negative electrode current collector and a negative electrode active material layer. The negative electrode current collector is not particularly limited in this application, provided that the purpose of this application can be achieved. For example, the negative electrode current collector may include copper foil, copper alloy foil, nickel foil, stainless steel foil, titanium foil, foamed nickel, foamed copper, or the like. The negative electrode active material layer in this application includes a negative electrode active material. A type of the negative electrode active material is not particularly limited in this application, provided that the purpose of this application can be achieved. For example, the negative electrode active material may include at least one of natural graphite, artificial graphite, mesocarbon microbead (MCMB), hard carbon, soft carbon, silicon, silicon-carbon composite, SiOₓ (0<x<2), Li—Sn alloy, Li—Sn—O alloy, Sn, SnO, SnO₂, spinel-structure lithium titanate Li₄Ti₅O₁₂, Li—Al alloy, or lithium metal. In this application, thicknesses of the negative electrode current collector and negative electrode active material layer are not particularly limited, provided that the purpose of this application can be achieved. For example, the thickness of the negative electrode current collector is 4 μm to 20 μm, and the thickness of the negative electrode active material layer is 30 μm to 130 μm. Optionally, the negative electrode active material layer may further include at least one of a conductive agent, a stabilizer, or a binder. Types of the conductive agent, stabilizer, and binder in the negative electrode active material layer are not particularly limited in this application, provided that the purpose of this application can be achieved. A mass ratio of the negative electrode active material, conductive agent, stabilizer, and binder in the negative electrode active material layer are not particularly limited in this application, provided that the purpose of this application can be achieved.

The separator is not particularly limited in this application, provided that the purpose of this application can be achieved. For example, the separator may include but is not limited to at least one of a polyethylene (PE), polypropylene (PP), and polytetrafluoroethylene-based polyolefin (PO) separator, a polyester film (for example, a polyethylene terephthalate (PET) film), a cellulose film, a polyimide film (PI), a polyamide film (PA), a spandex, an aramid film, a woven film, a non-woven film (non-woven fabric), a microporous film, a composite film, a separator paper, a stacked film, or a spinning film, and preferably PP. The separator in this application may be of a porous structure. A pore size is not particularly limited, provided that the purpose of this application can be achieved. For example, the pore size may be 0.01 μm to 1 μm. Thickness of the separator is not particularly limited in this application, provided that the purpose of this application can be achieved. For example, the thickness of the separator may be 5 μm to 500 μm.

For example, the separator may include a substrate layer and a surface treatment layer. The substrate layer may be a non-woven fabric, film, or composite film having a porous structure, and a material of the substrate layer may include but is not limited to at least one of polyethylene, polypropylene, polyethylene terephthalate, or polyimide. Optionally, a polypropylene porous film, a polyethylene porous film, polypropylene non-woven fabric, polyethylene non-woven fabric, or a polypropylene-polyethylene-polypropylene porous composite film may be used. Optionally, the surface treatment layer is provided on at least one surface of the substrate layer, and the surface treatment layer may be a polymer layer or an inorganic substance layer, or a layer formed by a mixture of a polymer and an inorganic substance.

The inorganic substance layer may include but is not limited to inorganic particles and an inorganic substance layer binder, and the inorganic particles are not particularly limited in this application, provided that the purpose of this application can be achieved. For example, the inorganic particles may include but are not limited to at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The inorganic substance layer binder is not particularly limited in this application. For example, the inorganic substance layer binder may include but is not limited to at least one of polyvinylidene fluoride, vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, or polyhexafluoropropylene. The polymer layer includes a polymer, and a material of the polymer may include but is not limited to at least one of polyamide, polyacrylonitrile, acrylate polymer, polyacrylic acid, polyacrylate salt, polyvinylpyrrolidone, polyvinyl ether, polyvinylidene fluoride, or polyvinylidene fluoride-hexafluoropropylene.

In this application, the secondary battery further includes an electrolyte including lithium salt and a nonaqueous solvent. The lithium salt may include at least one of LiPF₆, LiBF₄, LiClO₄, LiB(C₆H₅)₄, LiCH₃SO₃, LiCF₃SO₃, LIN (SO₂CF₃)₂, LiC(SO₂CF₃)₃, Li₂SiF₂, lithium bis(oxalate) borate (LiBOB), or lithium difluoroborate. Concentration of lithium salt in the electrolyte is not particularly limited in this application, provided that the purpose of this application can be achieved. For example, the concentration of lithium salt in the electrolyte may range from 0.9 mol/L to 1.5 mol/L. Exemplarily, the concentration may be 0.9 mol/L, 1.0 mol/L, 1.1 mol/L, 1.3 mol/L, 1.5 mol/L, or a range between any two of the above values. The nonaqueous solvent is not particularly limited in this application, provided that the purpose of this application can be achieved. For example, the nonaqueous solvent may include but is not limited to at least one of carbonate compound, carboxylate compound, ether compound, or another organic solvent. The carbonate compound may include but is not limited to linear carbonate compound, cyclic carbonate compound, or fluorocarbonate compound. The linear carbonate compound may include but is not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The foregoing cyclic carbonate may include but is not limited to at least one of ethylene carbonate (EC), propylene carbonate (PC), butylene carbonate (BC), or vinyl ethylene carbonate (VEC). The fluorocarbonate compound may include but is not limited to at least one of fluoroethylene carbonate (FEC), 4,5-difluoro-1,3-dioxolan-2-one, 4,4-difluoro-1,3-dioxolan-2-one, 4,4,5-trifluoro-1,3-dioxolan-2-one, 4,4,5,5-tetrafluoro-1,3-dioxolan-2-one, 4-fluoro-5-methyl-1,3-dioxolan-2-one, 4-fluoro-4-methyl-1,3-dioxolan-2-one, 4,5-difluoro-4-methyl-1,3-dioxolan-2-one, 4,4,5-trifluoro-5-methyl-1,3-dioxolan-2-one, or 4-trifluoroMethyl ethylence carbonate. The carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include but is not limited to at least one of dibutyl ether, tetraethylene glycol dimethyl ether, diglyme, 1,2-dimethoxyethane, 1,2-diethoxyethane, 1-ethoxy-1-methoxyethane, 2-methyltetrahydrofuran, or tetrahydrofuran. The another organic solvent may include but is not limited to at least one of dimethyl sulfoxide, 1,2-dioxolane, sulfolane, methyl-sulfolane, 1,3-dimethyl-2-imidazolidinone, N-methyl-2-pyrrolidone, methylamide, dimethylformamide, acetonitrile, trimethyl phosphate, triethyl phosphate, or trioctyl phosphate.

The secondary battery is not limited to a specific type in this application, and may include any apparatus in which an electrochemical reaction takes place. For example, the secondary battery may include but is not limited to: lithium metal secondary battery, lithium-ion secondary battery (lithium-ion battery), sodium-ion secondary battery (sodium-ion battery), lithium polymer secondary battery, and lithium-ion polymer secondary battery.

A shape of the secondary battery is not particularly limited in this application, provided that the purpose of this application can be achieved. For example, the shape of the secondary battery may include but is not limited to: rectangular, cylindrical, and irregular shapes (such as L-shaped and H-shaped).

The preparation method of secondary battery is not particularly limited in this application, and methods known in this field may be used, provided that the purpose of this application can be achieved. For example, the preparation method of secondary battery may include but is not limited to the following steps: a positive electrode plate, a separator, and a negative electrode plate are stacked in sequence, the resulting stack is subjected to operations such as winding and folding as needed to obtain an electrode assembly with a wound structure, the electrode assembly is put into a packaging bag, and the packaging bag is injected with an electrolyte and sealed to obtain a secondary battery; or a positive electrode plate, a separator, and a negative electrode plate are stacked in sequence, four corners of the entire stacked structure are fastened to obtain an electrode assembly with a stacked structure, the electrode assembly is put into a packaging bag, and the packaging bag is injected with an electrolyte and sealed to obtain a secondary battery.

A second aspect of this application provides an electronic apparatus, including the secondary battery according to any one of the foregoing embodiments. As a result, the electronic apparatus exhibits excellent safety performance.

The electronic apparatus in this application is not particularly limited, and the electronic apparatus may be any known electronic apparatus in the prior art. For example, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, or a lithium-ion capacitor.

### EXAMPLES

The following describes the embodiments of this application more specifically by using examples and comparative examples. Various tests and evaluations are performed in the following methods. In addition, unless otherwise specified, “part” and “%” are based on weight.

### Test Method and Device

### Peeling Strength Test:

The peeling strength of the adhesive member of a lithium-ion battery was tested according to GB/T 2792-2014 “Test Method for Peeling Strength of Adhesive Tapes.”
(1) The adhesive member was adhered to an aluminum foil and cut into strip-shaped samples of 20 mm×60 mm, with length adjusted proportionally as needed.
(2) The other side of the foregoing sample and the polypropylene surface of the packaging bag (25 mm×100 mm) was hot pressed at 85° C. and 1 MPa pressure for 40 minutes. Afterward, the sample was immersed in the electrolyte (with the same composition and preparation method as Example 1-1) at 85° C. for 4 hours. After immersion, the sample was wiped with a lint-free paper. Along a length direction of the sample, the sample was then pasted on a steel plate using a double-sided adhesive (Nichiban 5000NS), ensuring a pasted length of not less than 40 mm.
(3) The steel plate was fastened at a corresponding position of a Gotech tensile tester. Another end of the sample that was not attached to the adhesive member from the packaging bag was pulled, and the sample was placed in the grip head, with the pulled portion forming a 180° angle with the steel plate in space. The grip head pulled the sample at a speed of 5±0.2 mm/s. An average tension value in the steady range was finally measured and recorded as the peeling strength.

### Adhesive Fall-Off Caused by Friction Test:

The adhesive member of the lithium-ion battery was attached to the electrode assembly, with the other side of the adhesive member facing a conveyor belt (with surfaces attached with polytetrafluoroethylene and grid release paper, respectively). A contact friction was conducted at a speed of 0.1 m/s. After 2 hours, it was observed whether the adhesive fall-off occurred.

Adhesive fall-off caused by friction test pass rate=number of passed/total number of adhesive fall-off caused by friction test.

### Rolling Test:

The lithium-ion battery was left standing at room temperature for 60 minutes, and the voltage and capacity were measured. The measured values before dropping were: voltage 4.45 V, capacity 100%. The battery was then placed in a dedicated fixture and a dedicated rolling device was used in a test environment of 20±5° C. The battery was positioned 1 m above the ground and rolled 300 times at a speed of 4 turns per minute (2 drops count as 1 turn). After the rolling, voltage and capacity of the battery were measured and recorded, and the appearance was inspected and photographed both before and after the test.

Criteria: No fire, no explosion, no rupture, no smoke, no liquid leakage, voltage drop <50 m V.

Rolling test pass rate=number of passed/total number of rolling tests.

### Drop Test:

The lithium-ion battery was preconditioned at 25° C., left standing at room temperature for 60 minutes, and then the voltage and capacity were measured. The battery was placed in a dedicated fixture, and a specialized dropping device was used to perform free drops from a height of 1.5 m in the following order: head-tail-head-right corner-tail right corner-head left corner-tail left corner (angle: 45±15°). This process was repeated 6 times. After the drops, the voltage and capacity of the battery were measured and recorded, and the appearance was inspected and photographed both before and after the test.

Criteria: No fire, no explosion, no rupture, no smoke, no liquid leakage, voltage drop <30 mV after 24 hours of testing.

Drop test pass rate=number of passed/total number of drop tests.

### Example 1-1

### <Preparation of Positive Electrode Plate>

Lithium cobalt oxide (LiCoO₂) as a positive electrode active material, conductive agent nano carbon black, and binder polyvinylidene fluoride (PVDF) were mixed in a weight ratio of 97.5:1.0:1.5, and N-methylpyrrolidone (NMP) was added to prepare a slurry with a solid content of 75%, and the slurry was well stirred. The slurry was uniformly applied on a surface of an aluminum foil positive electrode current collector with a thickness of 9 μm and dried at 90° C. to obtain the positive electrode plate with a coating layer thickness of 110 μm. After the foregoing steps were completed, single surface coating of the positive electrode plate was completed. Then, the foregoing steps were repeated on the other surface of the positive electrode plate to obtain the positive electrode plate coated with positive electrode active materials on both surfaces. After the coating process, the positive electrode plate was cut to be used.

### <Preparation of Negative Electrode Plate>

A negative electrode active material powdered graphite, a conductive agent conductive carbon black (Super P), and a binder styrene-butadiene rubber (SBR) were mixed at a mass ratio of 96:1.5:2.5, added with deionized water as a solvent, and prepared into a negative electrode slurry with a solid content of 70%, and the negative electrode slurry was well stirred. The slurry was uniformly applied onto a surface of a negative electrode current collector copper foil with a thickness of 5 μm and dried at 110° C. to obtain a negative electrode plate having a negative electrode active material coated on one surface, with a coating of 130 μm in thickness. After the foregoing steps were completed, single surface coating of the negative electrode plate was completed. Then, the foregoing steps were repeated on the other surface of the negative electrode plate to obtain the negative electrode plate coated with positive electrode active materials on both surfaces. After the coating process, the negative electrode plate was cut to be used.

### <Preparation of Separator>

Aluminum oxide and polyvinylidene fluoride were mixed in a mass ratio of 90:10 and dissolved in deionized water to form a ceramic slurry with a solid content of 50%. The ceramic slurry was evenly applied on one side of a porous substrate (polyethylene, with a thickness of 7 μm, an average pore size of 0.073 μm, and a porosity of 26%) using a micro-gravure coating method, followed by drying, a double-layer structure of ceramic coating and porous substrate was obtained, with a ceramic coating thickness of 50 μm.

Polyvinylidene fluoride (PVDF) and polypropylene acrylic were mixed in a mass ratio of 96:4 and dissolved in deionized water to form a polymer slurry with a solid content of 50%. Then, the polymer slurry was uniformly applied on the two surfaces of the double-layer structure of the ceramic coating and the porous substrate through the micro-gravure coating method, and dried to obtain the separator. A thickness of a single-layer coating formed by the polymer slurry was 2 μm.

### <Preparation of Electrolyte>

In a dry argon atmosphere, organic solvents ethylene carbonate (EC), ethyl methyl carbonate (EMC), and diethyl carbonate (DEC) were mixed at a mass ratio of 30:50:20 to obtain an organic solution, and then a lithium salt lithium hexafluorophosphate was added to the organic solvents for dissolving and uniform mixing, to obtain the liquid electrolyte with a lithium salt concentration of 1.15 mol/L.

### <Preparation of Adhesive Member>

(1) Polyethylene terephthalate (PET) film was used as a substrate layer of the adhesive member, and a thickness of the substrate layer is 12 μm.
(2) Styrene-isoprene-styrene block copolymer (SIS), microcrystalline wax, polar resin (composed of a highly cohesive styrene-ethylene-butene-styrene block copolymer and polyolefin elastomer, with a mass ratio of highly cohesive styrene-ethylene-butene-styrene block copolymer to polyolefin elastomer at 7:3), ethylene-vinyl acetate copolymer, additive titanium dioxide, and antioxidant diphenylamine were mixed in a mass ratio of 75:5:5:10:2.5:2.5. After thorough mixing, the mixture was applied on the substrate layer to form the first adhesive layer, followed by drying at 120° C., and a thickness of the first adhesive layer was 8 μm.
(3) Polypropylene acrylic was applied on the other side of the substrate layer to form the second adhesive layer, followed by drying at 80° C., where a thickness of the second adhesive layer was 4 μm, and the adhesive member was obtained.

### <Preparation of Lithium-Ion Battery>

The prepared positive electrode plate and negative electrode plate were welded with tabs and stacked with the prepared separator in a sequence that the separator is between the positive and negative electrodes to separate the positive and negative electrodes, followed by winding, and a wound structure of the electrode assembly was obtained. As shown in FIG. 3, the adhesive member 30 was attached to outer surface of the electrode assembly 20, the assembly was placed into a housing 10, followed by processes such as top-side sealing, vacuum drying, electrolyte injection, formation, capacity testing, and evacuation, the secondary battery 100 was prepared.

### Examples 1-2 to 1-13

These examples were the same as Example 1-1 except that the preparation parameters were adjusted according to Table 1.

### Comparative Examples 1-1

These examples were the same as Example 1-1 except that the first adhesive layer uses only SIS adhesive during the preparation of the adhesive member.

### Comparative Examples 1-2

These examples were the same as Example 1-1 except that the first adhesive layer excludes wax during the preparation of the adhesive member and the preparation parameters was adjusted according to Table 1

### Comparative Examples 1-3 and 1-4

These examples were the same as Example 1-1 except that the preparation parameters were adjusted according to Table 1.

The relevant preparation parameters and performance tests for each example and comparative example are shown in Table 1.

TABLE 1

| | | | | | Mass | Mass | |
|---|---|---|---|---|---|---|---|
| | | | | Mass | percentage | percentage | Mass |
| | Mass | | Mass | percentage | of polar | of ethylene- | percentage |
| | percentage | | percentage | of polar | resin-polyolefin | vinyl acetate | of titanium |
| | of SIS | Type of | of wax | resin-SEBS | elastomer | copolymer | dioxide |
| | (%) | wax | (%) | (%) | (%) | (%) | (%) |
| Example | 75 | Microcrystalline | 5 | 3.5 | 1.5 | 10 | 2.5 |
| 1-1 | | wax | | | | | |
| Example | 75 | Microcrystalline | 4 | 3.5 | 1.5 | 11 | 2.5 |
| 1-2 | | wax | | | | | |
| Example | 75 | Microcrystalline | 3 | 3.5 | 1.5 | 12 | 2.5 |
| 1-3 | | wax | | | | | |
| Example | 75 | Microcrystalline | 2 | 3.5 | 1.5 | 12 | 2.5 |
| 1-4 | | wax | | | | | |
| Example | 75 | Microcrystalline | 1 | 3.5 | 1.5 | 14 | 2.5 |
| 1-5 | | wax | | | | | |
| Example | 75 | Microcrystalline | 3 | 3.5 | 1.5 | 12 | 2.5 |
| 1-6 | | wax | | | | | |
| Example | 75 | Microcrystalline | 3 | 3.5 | 1.5 | 12 | 2.5 |
| 1-7 | | wax | | | | | |
| Example | 75 | Microcrystalline | 3 | 3.5 | 1.5 | 12 | 2.5 |
| 1-8 | | wax | | | | | |
| Example | 75 | Microcrystalline | 3 | 3.5 | 1.5 | 12 | 2.5 |
| 1-9 | | wax | | | | | |
| Example | 60 | Polyethylene | 3 | 4 | 6 | 22 | 2.5 |
| 1-10 | | wax | | | | | |
| Example | 65 | Microcrystalline | 3 | 5 | 5 | 17 | 2.5 |
| 1-11 | | wax | | | | | |
| Example | 85 | Microcrystalline | 3 | 1 | 1 | 7 | 1.5 |
| 1-12 | | wax | | | | | |
| Example | 95 | Microcrystalline | 1 | 1 | 1 | 1 | 0.5 |
| 1-13 | | wax | | | | | |
| Comparative | 100 | / | / | / | / | / | / |
| example | | | | | | | |
| 1-1 | | | | | | | |
| Comparative | 75 | / | / | 3.5 | 1.5 | 15 | 2.5 |
| example | | | | | | | |
| 1-2 | | | | | | | |
| Comparative | 75 | Microcrystalline | 0.5 | 3.5 | 1.5 | 14.5 | 2.5 |
| example | | wax | | | | | |
| 1-3 | | | | | | | |
| Comparative | 75 | Microcrystalline | 8 | 3.5 | 1.5 | 7 | 2.5 |
| example | | wax | | | | | |
| 1-4 | | | | | | | |

| | | | Peeling | Pass | | |
|---|---|---|---|---|---|---|
| | | | strength | rate of | | |
| | Mass | Thickness | between first | adhesive | | |
| | percentage | of first | adhesive | fall-off | Pass | Pass |
| | of diphenyl- | adhesive | layer and | caused by | rate of | rate of |
| | amine | layer | housing | friction | rolling | drop |
| | (%) | (μm) | (N/m) | test | test | test |
| Example | 2.5 | 8 | 253.3 | 10/10 | 7/10 | 6/10 |
| 1-1 | | | | | | |
| Example | 2.5 | 8 | 297.2 | 9/10 | 9/10 | 9/10 |
| 1-2 | | | | | | |
| Example | 2.5 | 8 | 308.9 | 10/10 | 10/10 | 10/10 |
| 1-3 | | | | | | |
| Example | 2.5 | 8 | 318.9 | 9/10 | 9/10 | 8/10 |
| 1-4 | | | | | | |
| Example | 2.5 | 8 | 325.5 | 5/10 | 10/10 | 10/10 |
| 1-5 | | | | | | |
| Example | 2.5 | 2 | 106.9 | 10/10 | 10/10 | 10/10 |
| 1-6 | | | | | | |
| Example | 2.5 | 12 | 389.8 | 10/10 | 10/10 | 10/10 |
| 1-7 | | | | | | |
| Example | 2.5 | 16 | 445.4 | 10/10 | 10/10 | 10/10 |
| 1-8 | | | | | | |
| Example | 2.5 | 20 | 478.9 | 10/10 | 10/10 | 10/10 |
| 1-9 | | | | | | |
| Example | 2.5 | 8 | 157.4 | 10/10 | 10/10 | 10/10 |
| 1-10 | | | | | | |
| Example | 2.5 | 8 | 228.6 | 10/10 | 10/10 | 10/10 |
| 1-11 | | | | | | |
| Example | 1.5 | 8 | 411.5 | 10/10 | 8/10 | 10/10 |
| 1-12 | | | | | | |
| Example | 0.5 | 8 | 545.2 | 10/10 | 9/10 | 9/10 |
| 1-13 | | | | | | |
| Comparative | / | 8 | 568.5 | 0/10 | 8/10 | 6/10 |
| example | | | | | | |
| 1-1 | | | | | | |
| Comparative | 2.5 | 8 | 432.9 | 0/10 | 7/10 | 5/10 |
| example | | | | | | |
| 1-2 | | | | | | |
| Comparative | 2.5 | 8 | 317.4 | 2/10 | 7/10 | 5/10 |
| example | | | | | | |
| 1-3 | | | | | | |
| Comparative | 2.5 | 8 | 122.7 | 10/10 | 1/10 | 0/10 |
| example | | | | | | |
| 1-4 | | | | | | |

Note:
In Table 1, “/” indicates that there is no corresponding preparation parameter.

From Example 1-1 to Example 1-13 and Comparative Example 1-1 to Comparative Example 1-4, it can be seen that the addition of wax can improve the occurrence of adhesive fall-off caused by friction and further enhance the safety performance of the secondary battery. In the ordinary SIS adhesive member, during the use of the lithium-ion battery, the high stickiness of the first adhesive layer containing only SIS results in a weaker adhesion to the substrate layer, and dust accumulates on the pull-tab surface, a frictional resistance is high, leading to the occurrence of adhesive fall-off caused by friction. Adding a proper amount of wax in the first adhesive layer can reduce the surface stickiness of the first adhesive layer and the occurrence of adhesive fall-off caused by friction on the adhesive member during the preparation of secondary battery, thereby increasing a pass rate of adhesive fall-off caused by friction test. Furthermore, the pass rates of rolling test and drop test in Example 1-1 to Example 1-13 are both higher than those in Comparative example 1-2, further demonstrating that the addition of wax can improve the stability of the lithium-ion battery during use and thus enhance the safety performance of the lithium-ion battery.

A mass percentage of wax usually affects the safety performance of the lithium-ion battery. From Example 1-1 to Example 1-5, it can be seen that when the mass percentage of wax is within the scope of this application, the surface stickiness of the first adhesive layer is reduced, reducing the occurrence of adhesive fall-off caused by friction and thus enhancing the safety performance of the lithium-ion battery. From Example 1-2 to Example 1-4, when the mass percentage of wax is 2% to 4%, the pass rate of adhesive fall-off caused by friction test of the lithium-ion battery is higher, and compared with Example 1-1, the pass rates of rolling test and drop test in Example 1-2 to Example 1-4 increase, further enhancing the safety performance of the lithium-ion battery.

A mass percentage of polar resin usually affects the safety performance of the lithium-ion battery. From Example 1-1 to Example 1-9, it can be seen that when the mass percentage of polar resin is within the scope of this application, the pass rates of rolling test and drop test are higher, thus enhancing the safety performance of the lithium-ion battery.

The thickness of the first adhesive layer usually affects the safety performance of the lithium-ion battery. From Example 1-6 to Example 1-9, it can be seen that as the thickness of the first adhesive layer increases, the peeling strength between the first adhesive layer and the housing increases accordingly, thus enhancing the safety performance of the lithium-ion battery.

Changes in mass percentages of the additive and the antioxidant usually affect the peeling strength between the first adhesive layer and the housing, thus affecting the safety performance of the lithium-ion battery. From Example 1-3, Example 1-11 to Example 1-13, it can be seen that when the mass percentage of SIS is within the range of this application, as the mass percentage of SIS increases, the peeling strength between the first adhesive layer and the housing increases accordingly. However, when the peeling strength exceeds 500 N/m, there is a possibility of tearing the aluminum foil, reducing the safety performance of the lithium-ion battery.

In conclusion, adding wax to the first adhesive layer of the secondary battery adhesive member can reduce the surface stickiness of the first adhesive layer and the occurrence of adhesive fall-off of the adhesive member caused by friction during the preparation of the secondary battery, and further enhancing the safety performance of the secondary battery, meeting the mass production processability of the secondary battery.

It should be noted that the terms “include”, “comprise”, or any of their variants are intended to cover a non-exclusive inclusion, such that a process, method, or article that includes a series of elements includes not only those elements but also other elements that are not expressly listed, or further includes elements inherent to such process, method, or article.

The embodiments in this specification are all described in a related manner. For same or similar parts in the embodiments, mutual reference may be made. Each embodiment focuses what is different from other embodiments.

The foregoing descriptions are merely preferred examples of this application, and are not intended to limit the protection scope of this application. Any modifications, equivalent replacements, and improvements made without departing from the spirit and principle of this application shall fall within the protection scope of this application.

What is claimed is:

1. A secondary battery, comprising an electrode assembly, an electrolyte, a housing, and an adhesive member; wherein the adhesive member comprises a first adhesive layer and a second adhesive layer stacked together, and the adhesive member is disposed between the electrode assembly and the housing; wherein the first adhesive layer is attached to an inner surface of the housing, and the second adhesive layer is attached to an outer surface of the electrode assembly; the first adhesive layer comprises a styrene-isoprene-styrene block copolymer and wax; and based on a mass of the first adhesive layer, a mass percentage of the wax is 1% to 5%.

2. The secondary battery according to claim 1, wherein the wax comprises at least one of microcrystalline wax, paraffin wax, carnauba wax, polyethylene wax, or polypropylene wax.

3. The secondary battery according to claim 1, wherein based on the mass of the first adhesive layer, the mass percentage of the wax is 2% to 4%.

4. The secondary battery according to claim 1, wherein the first adhesive layer further comprises a functional resin; based on the mass of the first adhesive layer, a mass percentage of the styrene-isoprene-styrene block copolymer is 65% to 95%, and a mass percentage of the functional resin is 10% to 30%; and the functional resin comprises at least one of ethylene-vinyl acetate copolymer, polyurethane elastomer, polyurethane acrylate, polyisobutylene, or polybutadiene.

5. The secondary battery according to claim 1, wherein the first adhesive layer further comprises an additive and an antioxidant; and
based on the mass of the first adhesive layer, a mass percentage of the additive is 1% to 5%, and a mass percentage of the antioxidant is 1% to 5%.

6. The secondary battery according to claim 1, wherein the adhesive member further comprises a substrate layer, and the substrate layer is located between the first adhesive layer and the second adhesive layer; and the substrate layer comprises at least one of polyethylene terephthalate, polyimide, or polypropylene.

7. The secondary battery according to claim 6, wherein the first adhesive layer further comprises a polar resin, and the polar resin comprises a styrene-ethylene-butylene-styrene block copolymer and a polyolefin elastomer; and
based on the mass of the first adhesive layer, a mass percentage of the polar resin is 5% to 10%, a mass percentage of the styrene-ethylene-butylene-styrene block copolymer is 3.5% to 9.5%, and a mass percentage of the polyolefin elastomer is 0.5% to 1.5%.

8. The secondary battery according to claim 1, wherein the housing is a packaging bag.

9. The secondary battery according to claim 1, wherein a thickness of the first adhesive layer is 2 μm to 20 μm.

10. The secondary battery according to claim 1, wherein a peeling strength between the first adhesive layer and the housing is 10 N/m to 500 N/m.

11. An electronic apparatus, wherein the electronic apparatus comprises a secondary battery;
the secondary battery comprises an electrode assembly, an electrolyte, a housing, and an adhesive member, wherein the adhesive member comprises a first adhesive layer and a second adhesive layer stacked together, and the adhesive member is disposed between the electrode assembly and the housing; wherein the first adhesive layer is attached to an inner surface of the housing, and the second adhesive layer is attached to an outer surface of the electrode assembly; the first adhesive layer comprises a styrene-isoprene-styrene block copolymer and wax; and based on a mass of the first adhesive layer, a mass percentage of the wax is 1% to 5%.

12. The electronic apparatus according to claim 11, wherein the wax comprises at least one of microcrystalline wax, paraffin wax, carnauba wax, polyethylene wax, or polypropylene wax.

13. The electronic apparatus according to claim 11, wherein based on the mass of the first adhesive layer, the mass percentage of the wax is 2% to 4%.

14. The electronic apparatus according to claim 11, wherein the first adhesive layer further comprises a functional resin; based on the mass of the first adhesive layer, a mass percentage of the styrene-isoprene-styrene block copolymer is 65% to 95%, and a mass percentage of the functional resin is 10% to 30%; and the functional resin comprises at least one of ethylene-vinyl acetate copolymer, polyurethane elastomer, polyurethane acrylate, polyisobutylene, or polybutadiene.

15. The electronic apparatus according to claim 11, wherein the first adhesive layer further comprises an additive and an antioxidant; and
based on the mass of the first adhesive layer, a mass percentage of the additive is 1% to 5%, and a mass percentage of the antioxidant is 1% to 5%.

16. The electronic apparatus according to claim 11, wherein the adhesive member further comprises a substrate layer, and the substrate layer is located between the first adhesive layer and the second adhesive layer; and the substrate layer comprises at least one of polyethylene terephthalate, polyimide, or polypropylene.

17. The electronic apparatus according to claim 16, wherein the first adhesive layer further comprises a polar resin, and the polar resin comprises a styrene-ethylene-butylene-styrene block copolymer and a polyolefin elastomer; and
based on the mass of the first adhesive layer, a mass percentage of the polar resin is 5% to 10%, a mass percentage of the styrene-ethylene-butylene-styrene block copolymer is 3.5% to 9.5%, and a mass percentage of the polyolefin elastomer is 0.5% to 1.5%.

18. The electronic apparatus according to claim 11, wherein the housing is a packaging bag.

19. The electronic apparatus according to claim 11, wherein a thickness of the first adhesive layer is 2 μm to 20 μm.

20. The electronic apparatus according to claim 11, wherein a peeling strength between the first adhesive layer and the housing is 10 N/m to 500 N/m.
